(19) United States
(12) Patent Application Publication
(10) Pub. No.: US 2022/0341751 A1
(43) Pub. Date: Oct. 27, 2022

(54) SYSTEMS AND METHODS FOR MULTI-SENSOR MAPPING USING A SINGLE DEVICE THAT CAN OPERATE IN MULTIPLE MODES

(71) Applicants: Ahmed Shaker Abdelrahman, Oakville (CA); Ashraf Mohamed Abdelaziz Elshorbagy, North York (CA)

(72) Inventors: Ahmed Shaker Abdelrahman, Oakville (CA); Ashraf Mohamed Abdelaziz Elshorbagy, North York (CA)

(21) Appl. No.: 17/636,537

(22) PCT Filed: Aug. 20, 2020
(86) PCT No.: PCT/CA2020/051133

§ 371 Date: Feb. 18, 2022

Related U.S. Application Data
(60) Provisional application No. 62/889,845, filed on Aug. 21, 2019.

(51) Int. Cl. G01C 21/00; G01S 19/47; G01S 17/89; G01S 17/86

(52) U.S. Cl. CPC G01C 21/3848; G01S 19/47; G01S 17/89; G01S 17/86

(57) ABSTRACT

Systems and methods for multi-sensor mapping are provided for a multi-sensor device having a range sensor, a location sensor and an orientation sensor that provide range data, location data and orientation data, respectively. The device may be operated in a stationary mode, a mobile ground mode or an airborne mode. The range data, the location data and the orientation data are combined to generate three-dimensional geo-referenced point cloud data.

### CROSS-REFERENCE

This application claims the benefit of U.S. Provisional Patent Application No. 62/889,845, filed Aug. 21, 2019, and the entire contents of U.S. Provisional Patent Application No. 62/889,845 are hereby incorporated by reference.

### FIELD

Various embodiments are described herein that generally relate to systems and methods for multi-sensor mapping, and, more particularly to systems and methods for generating mapping data using a range sensor, a location sensor and an orientation sensor in a single device. The system can also accommodate and integrate other sensors.

### BACKGROUND

Light detection and ranging (LiDAR) is a mapping or surveying method that measures distance (or range) to a target by illuminating the target with laser light and recording the reflected light with the transmitted sensor. The measured time difference between illumination and sensing of the reflected light is used to calculate the distance or range to the target. The laser light is scanned across a surface to measure the surface characteristics and generate corresponding mapping data. LiDAR-based mapping is used in many applications such as, for example, geography, geology, archaeology, forestry, atmospheric physics, and autonomous car navigation.

Conventional LiDAR data acquisition systems are designed for specific modes of operation and are often large, heavy and expensive. For example, conventional LiDAR data acquisition systems designed for long-range, high-precision, stationary mode of operation (where the system may be mounted on a tripod) with a maximum range greater than 500 meters may weigh greater than 10 kg. Similarly, conventional LiDAR data acquisition systems designed for medium-range mobile mode of operation (where the system may be mounted on a truck or a minivan) with an average range of approximately 200 meters may weigh more than 8 kg. Conventional LiDAR data acquisition systems designed for short-range, light-weight, airborne mode of operation (where the system is mounted on a drone) with a maximum range of less than 100 meters may weigh approximately 2 kg. Further, conventional systems are often manufactured with proprietary LiDAR sensors and do not provide the ability to add new non-proprietary sensors and data processing components.

### SUMMARY OF VARIOUS EMBODIMENTS

According to one aspect of the teachings herein, there is provided a multi-sensor mapping system for generating mapping data, the multi-sensor mapping system comprising a device having a housing that is platform independent and adapted for coupling to different platforms for different modes of operation; a range sensor that is mounted to the housing and configured to sense a distance between the range sensor and a target point and generate range data; a location sensor that is mounted to the housing and configured to sense a location of the range sensor and generate location data; an orientation sensor that is mounted to the housing and configured to sense an orientation of the range sensor in relation to a gravitational frame of reference and generate orientation data; and a system management unit that is operatively coupled to the sensors and configured to control the operation of the sensors in a stationary mode, a ground mobile mode or an airborne mode.

In at least one embodiment, the system further comprises a data processing unit that is communicatively coupled to the device for receiving the range data, location data and orientation data and generating the mapping data by combining the received range data, location data and orientation data into three-dimensional geo-referenced point cloud data.

In at least one embodiment, the range sensor is rotatably mounted to the housing for rotation with three degrees of freedom comprising: an internal rotation angle around a spinning axis of the range sensor; a vertical rotation angle around one of two mutually orthogonal horizontal axes; and a horizontal rotation angle around an absolute vertical axis that is orthogonal to the two mutually orthogonal horizontal axes.

In at least one embodiment, the system management unit is configured to: control at least one of the vertical rotation angle and the horizontal rotation angle of the range sensor to perform at least one of expanding a field-of-view of the range sensor and increasing a density of target data points that is sensed by the range sensor.

In at least one embodiment, the data processing unit is configured to generate the mapping data by: pre-processing the received range data through frame data discretization; pre-processing the received location and orientation data; interpolating the pre-processed location and orientation data using synchronized timestamps and an application-dependent step interval; combining the interpolated data by using vectorization; transforming coordinate system frames for the combined data to a common coordinate system frame to generate transformed data; generating a three-dimensional geo-referenced point cloud data from the transformed data; and post-processing the three-dimensional geo-referenced point cloud data.

In at least one embodiment, the data processing unit is configured to receive a first control input of selected frames from an operator of the system and use the first control input for analysis and processing the range data.

In at least one embodiment, the data processing unit is configured to determine the step interval using different interval ranges depending on whether the system is operating in the stationary mode, the ground mobile mode, or the airborne mode.

In at least one embodiment, the system management unit and the data processing unit employ at least one common processor.

In at least one embodiment, the range sensor is configured to obtain the range data when the system is incrementally moved in a given direction resulting in the obtained range data covering an extended field of view.

In at least one embodiment, the data processing unit is configured to use the range data obtained over the larger field of view to increase density for the generated three-dimensional geo-referenced point cloud data.

In another aspect, in accordance with the teachings herein, there is provided a method for generating mapping data using a multi-sensor mapping system. The method comprises: configuring the multi-sensor mapping system for operating in a stationary mode, a ground mobile mode or an airborne mode, where the multi-sensor system comprises a range sensor configured to sense a distance between the range sensor and a target point and generate range data; a location sensor configured to sense a location of the range sensor and generate location data; and an orientation sensor configured to sense an orientation of the range sensor in relation to a gravitational frame of reference and generate orientation data; controlling, during operation of the range sensor, an internal rotation angle of the range sensor around a spinning axis, a vertical rotation angle of the range sensor around one of two mutually orthogonal horizontal axes and a horizontal rotation angle of the range sensor around a vertical axis orthogonal to the two mutually orthogonal horizontal axes; receiving the range data from the range sensor; receiving the location data from the location sensor; receiving the orientation data from the orientation sensor; and generating the mapping data by combining the received range data, location data and orientation data.

In at least one embodiment, the mapping data is generated by: pre-processing the received range data through frame data discretization; pre-processing the received location and orientation data; interpolating the pre-processed location and orientation data using synchronized timestamps and an application-dependent step interval; combining the interpolated data by using vectorization; transforming coordinate system frames for the combined data to a common coordinate system frame to generate transformed data; generating a three-dimensional geo-referenced point cloud data from the transformed data; and post-processing the three-dimensional geo-referenced point cloud data.

In at least one embodiment, the method comprises receiving a first control input of selected frames from an operator of the system for analysis and processing the range data.

In at least one embodiment, the method comprises determining the step interval using different interval ranges depending on whether the system is operating in the stationary mode, the ground mobile mode, or the airborne mode.

In at least one embodiment, wherein the method further comprises obtaining the range data when the system is incrementally moved in a given direction resulting in the obtained range data covering an extended field of view.

In at least one embodiment, the method comprises using the range data obtained over the larger field of view to increase density for the generated three-dimensional geo-referenced point cloud data.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows a component block diagram and associated data flow of a multi-sensor mapping system according to an example embodiment of the present disclosure.

FIG. 1B shows a component block diagram of an example embodiment of a system management unit that may be used with a multi-sensor mapping system according to an example embodiment of the present disclosure.

FIG. 2A shows an isometric view of a physical layout of a multi-sensor mapping system according to an example embodiment of the present disclosure.

FIGS. 2B and 2C show front perspective views of housing components for the multi-sensor mapping system of FIG. 2A.

FIG. 3 shows a visual representation of the three degrees of freedom of rotation of a range sensor that is used with the multi-sensor mapping system, according to an example embodiment of the present disclosure.

FIG. 4A shows a schematic of a multi-sensor mapping system operated according to a first configuration in stationary mode, according to an example embodiment of the present disclosure.

FIG. 4B shows an image of an example embodiment of a multi-sensor mapping system operated in the first configuration in stationary mode, according to an example embodiment of the present disclosure.

FIG. 4C shows a schematic of a multi-sensor mapping system operated according to a second configuration in stationary mode, according to an example embodiment of the present disclosure.

FIG. 4D shows an example of a multi-sensor mapping system operated according to the second configuration in stationary mode, according to an example embodiment of the present disclosure.

FIG. 4E shows an example of a structure to be mapped.

FIG. 4F shows an example of a point cloud of a mapped area of the structure of FIG. 4E obtained using a conventional mapping device.

FIG. 4G shows an example of a point cloud of a mapped area of the structure of FIG. 4E obtained using a multi-sensor mapping system with increased scan coverage in accordance with the teachings herein.

FIG. 4H shows an example of another point cloud of a mapped area of the structure of FIG. 4E obtained using a multi-sensor mapping system with increased scan coverage in accordance with the teachings herein.

FIG. 5A shows a schematic of a multi-sensor mapping system operated in a ground mobile mode, according to an example embodiment of the present disclosure.

FIG. 5B shows an image of an example embodiment of a multi-sensor mapping system that is configured to operate in ground mobile mode, according to an example embodiment of the present disclosure.

FIG. 5C shows a schematic of a multi-sensor mapping system operated in a ground mobile mode, according to another example embodiment of the present disclosure.

FIG. 5D shows a schematic of a multi-sensor mapping system operated in a first configuration in ground mobile mode, according to another example embodiment of the present disclosure.

FIG. 5E shows a schematic of a multi-sensor mapping system operated in a second configuration in ground mobile mode, according to an example embodiment of the present disclosure.

FIG. 5F shows an image of an example embodiment of a multi-sensor mapping system in the second configuration for operation in ground mobile mode, according to an example embodiment of the present disclosure.

FIG. 6 shows a schematic of a multi-sensor mapping system operated in an airborne mode, according to an example embodiment of the present disclosure.

FIG. 7 shows a flowchart of an example embodiment of a method for generating mapping data using a multi-sensor mapping system in accordance with the teachings herein.

FIG. 8 shows a flowchart of an example embodiment of a method that can be used with the method of FIG. 7 for processing raw mapping data to generate the mapping data by a multi-sensor mapping system in accordance with the teachings herein.

FIG. 9 shows a visual representation of the different coordinate system frames used in a multi-sensor mapping system in accordance with the teachings herein.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

At least a portion of the example embodiments of the apparatuses or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory).

It should also be noted that there may be some elements that are used to implement at least part of the embodiments described herein that may be implemented via software that is written in a high-level procedural language such as object-oriented programming. The program code may be written in JAVA, C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media (e.g., a computer readable medium such as, but not limited to, ROM, flash memory, magnetic disk, optical disc) or a device that is readable by a programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, DVD, tapes, chips, and magnetic, optical and electronic storage. In at least one alternative embodiment, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

In one aspect, in at least one example embodiment discussed herein, there is provided a system and method for generating mapping data using a range sensor configured to sense the distance to a target point, a location sensor configured to sense the location of the range sensor, and an orientation sensor configured to sense the orientation of the range sensor. The mapping data can be generated by combining the data generated by the range sensor, the location sensor and the orientation sensor.

In another aspect, the example embodiments described herein generally have a small form-factor and a low-weight (e.g. less than 1.5 kg) and utilize data integration to enable operation in any of a stationary, ground mobile and airborne mode of operation.

In contrast, as described hereinbefore, conventional systems are designed for one particular mode of operation. Accordingly, a single conventional system cannot be operated effectively in stationary, ground mobile and airborne modes of operation. Multiple separate conventional systems are generally required for obtaining mapping data for these multiple modes of operation and in such cases the conventional systems do not provide data consistency for data obtained from these various modes of operation.

In another aspect, in at least one embodiment, a user can use a wireless controller to select the mode of operation and control a multi-sensor mapping system in accordance with the teachings herein.

In another aspect, at least one of the example embodiments discussed herein may provide a flexible, modular system by including a housing that is pre-marked to receive additional sensors at pre-marked locations with pre-determined orientations. In contrast, conventional systems are often manufactured with certain types of proprietary sensors and do not provide a similar flexible and modular feature to add additional sensors after the conventional system is manufactured.

In another aspect, in at least one of the example embodiments discussed herein, the range sensor can be configured for rotation with three degrees of freedom comprising an internal rotation angle around a spinning axis of the range sensor; a vertical rotation angle around one of two mutually orthogonal horizontal axes; and a horizontal rotation angle around a vertical axis that is orthogonal to the two mutually orthogonal horizontal axes. Such embodiments include a system management unit configured to control the vertical and/or the horizontal rotation angle to expand the field-of-view of the range sensor and to increase a density of target points mapped by the range sensor. This may provide the advantage of increased efficiency, compared with conventional systems, during mapping. For example, and without limitation, in a drone-based airborne mapping application, the ability to rotate the range sensor along these new rotation angles provides an expanded field-of-view to enable range data to be collected over a larger area while the drone is stationary. In contrast, a drone with a conventional sensor system needs to travel along a larger flight path to collect the same amount of range data.

In another aspect, at least one of the embodiments described herein enables complete user control of the imported data by allowing the user to select each individual frame (or select each individual scan) or group of frames (or group of scans) of the range data for processing. This may provide the advantages of increased user control in choosing key frames, a desired frame-rate, or frames for later analysis (which can speed up processing time of key frames); faster analysis by allowing parallel computation or cloud-based computation of the imported data and increased efficiency by allowing for targeted analysis of selected frames.

In another aspect, in at least one embodiment, the multi-sensor system described in accordance with the teachings herein can use vectorization to interpolate the location and orientation data, and to match it to timestamped range data, thereby speeding up processing.

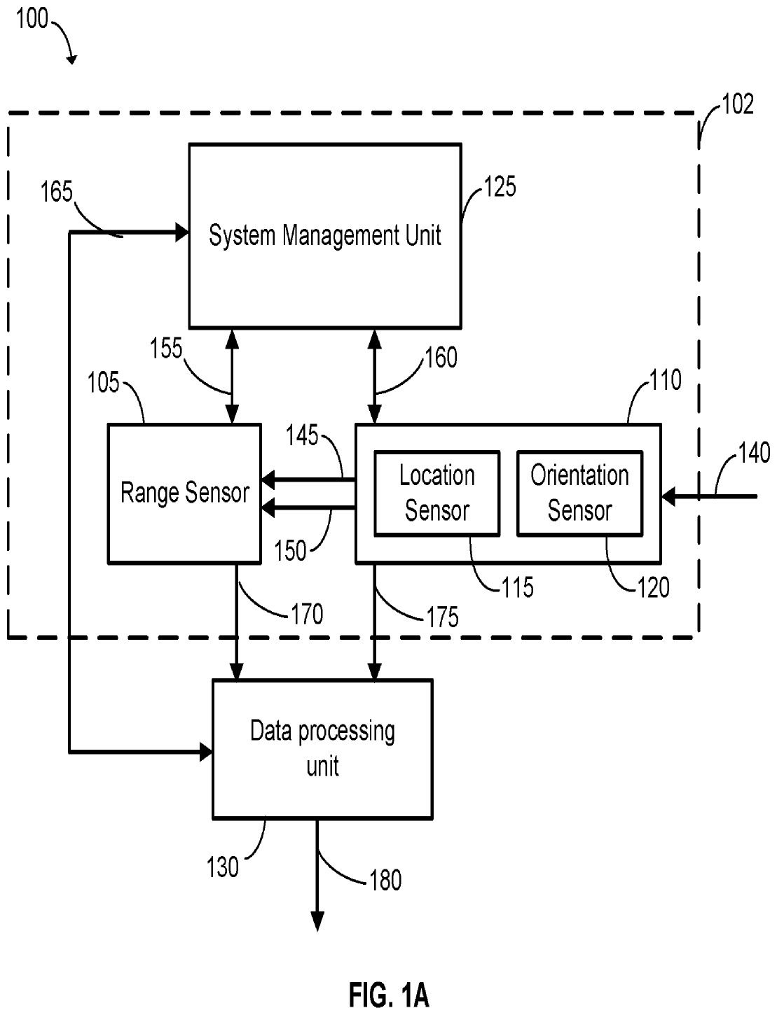

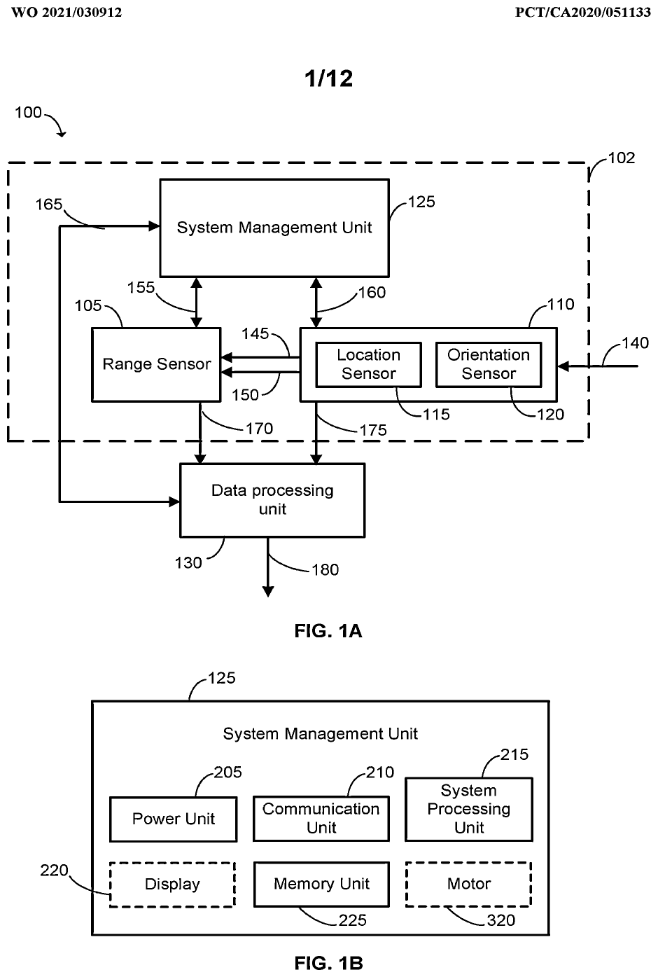

Reference is first made to FIG. 1A, which shows a component block diagram and associated data flow of a multi-sensor mapping system 100 according to an example embodiment of the present disclosure. The system 100 comprises a range sensor 105, a position and orientation system (POS) 110, a system management unit 125 and a data processing unit 130. The range sensor 105, the POS 110, and the system management unit 125 are all mounted within a single device 102. The system management unit 125 is generally used to operate and control the sensors to record data. The system management unit 125 then stores the recorded data. For example, the system processing unit 215 may access associated memory (e.g. see FIG. 1B) having software instructions that configures the system processing unit 215 for performing method 700 to obtain and store the sensor data. The data processing unit 130 is used to generate a 3D geo-referenced point cloud data. The data processing unit 130 may be a part of another device such as a desktop computer, a tablet, a laptop, a server, or a cloud computer. For example, the data processing unit 130 may access associated memory (not shown) having software instructions that configures the data processing unit 130 to perform a method, such as method 800, to generate the 3D geo-referenced point cloud data.

The range sensor 105 may comprise a Remote Sensing Sensor (RSS) which may be an active and/or a passive sensor. For example, and without limitation, passive sensors may include digital cameras (monocular or stereo), multispectral cameras, or hyperspectral cameras while the active sensors may include LiDAR or radar sensors. When the range sensor 105 includes a LiDAR scanner, the range sensor 105 includes a laser source to illuminate a target point and a detector to detect and record the reflected light. The measured time difference between generating an illumination signal and sensing the reflected light is used to calculate the distance to the target point. The range sensor 105 may include a scanner to scan the laser light across a surface to measure the surface characteristics and generate corresponding three-dimensional (3D) point-cloud data. In at least one embodiment, the range sensor 105 may receive a Pulse Per Second (PPS) signal 145 and a GPRMC message 150 or the like that includes minutes and seconds defined using the Coordinated Universal Time UTC time standard that are used for timestamping the data. GPRMC stands for GPS recommended minimum navigation data and is a NMEA message format. Upon synchronization, the range sensor 105 uses the UTC time data and the PPS signal 145 to generate 3D time-stamped point-cloud data 170 which is then sent to the data processing unit 130. The range sensor 105 generally includes a range processor (not shown) that controls the operation of the range sensor 105 and sends and receives data to other components of the multi-sensor mapping system 100.

The POS 110 includes a location sensor 115 and an orientation sensor 120. For example, and without limitation, the location sensor 115 may comprise a global navigation satellite system (GNSS) receiver that is configured to generate autonomous geo-spatial location data. The location sensor 115 receives a GNSS signal 140 to determine the geo-spatial location of the range sensor 105 and generate corresponding location data. Higher accuracy is attained with multi-frequency GNSS receivers as more errors can be corrected. Moreover, multi-frequency receivers are more immune to interference. In addition, if the GNSS receiver is a multi-constellation receiver then it can access signals from several satellite systems/constellations such as: GPS, GLONASS, BeiDou and Galileo resulting in increasing the number of satellites within the GNSS receiver field of view. The increased number of satellites that can be tracked has several benefits such as reduced signal acquisition time, and improved distribution of satellite geometry which results in improved dilution of precision. Hence, improved position and time accuracy may be attained. The location sensor 115 generally includes a location processor (not shown) that controls the operation of the location sensor 115 and sends and receives data to other components of the multi-sensor mapping system 100.

The orientation sensor 120 generally includes an inertial measurement unit (IMU) configured to generate orientation data for the range sensor 105 in relation to a gravitational frame of reference in order to measure the orientation of the range sensor 105. For example, and without limitation, the orientation sensor 120 may include a number of accelerometers and gyros in a defined orientation in order to measure the movement of its body in three-dimensional space.

The POS 110 can provide the generated location and orientation data 175 to the data processing unit 130. Light-weight components can be chosen for POS 110 to enable operation of system 100 in any of a stationary, a ground mobile and an airborne mode of operation. The orientation sensor 120 generally includes a location processor (not shown) that controls the operation of the location sensor 120 and sends and receives data to other components of the multi-sensor mapping system 100.

The accurate association of the location and the orientation data recorded by the POS 110 and the Laser beams fired by the range sensor 105, in accordance with the teachings herein, provides for the creation of accurate 3D georeferenced point cloud calculations. In order to allow for this accurate association, the data from the range sensor 105 and the data from the POS 110 are timestamped to the same time reference frame. The precise and accurate signal synchronization between the range sensor 105 and the POS 110 ensures the proper timestamping process. The POS 110 generates the sequential synchronization Pulse Per Second (PPS) signal 145 and a NMEA $GPRMC message 150 or the like. The range sensor 105 receives the PPS signal 145 and the $GPRMC message 150, such as through a communication module for example, thereby allowing the timestamping of the range sensor 105 data to be done per the same time reference frame as that used by the POS 110.

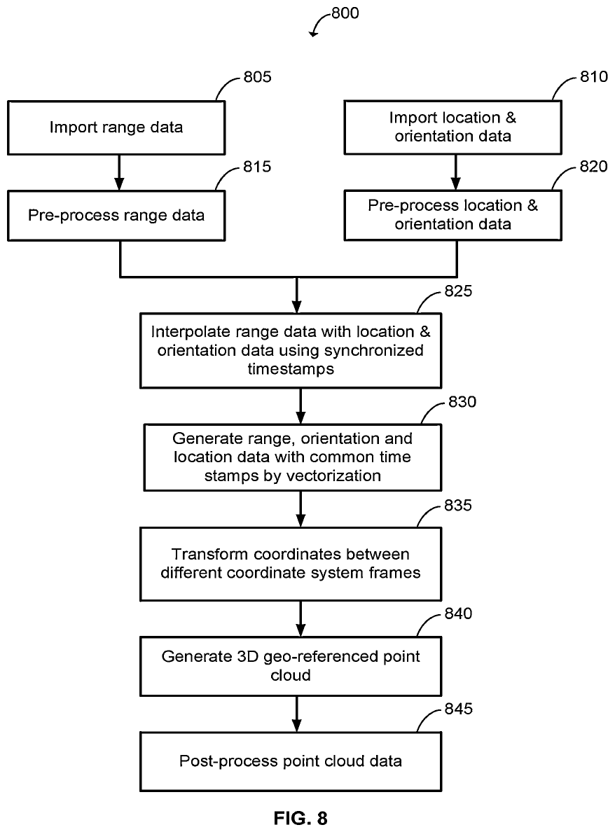

The data processing unit 130 may receive 3D time-stamped point-cloud data 170 from range sensor 105 and location and orientation data 175 from the POS 110. The data processing unit 130 can then process the received data to generate 3D geo-referenced point cloud data 180. The data processing unit 130 may be implemented in a similar fashion as the system processing unit 215 described below but have more processing power. For example, the data processing unit 130 may include a high performance general processor. In alternative embodiments, the data processing unit 130 may include more than one processor with each processor being configured to perform different dedicated tasks. In alternative embodiments, specialized hardware can be used to provide some of the processing functions provided by the data processing unit 130, such as in a cloud computing environment. The processing of data by the data processing unit 130 is explained in further detail below with reference to FIG. 8. In some embodiments, at least one common processor (e.g. a single data processing unit) may be used in the device 102 instead of having a separate data processing unit 130 and a system processing unit 215.

Reference is now made to FIG. 1B, which shows a component block diagram of system management unit 125 according to an example embodiment of the present disclosure. The system management unit 125 controls the operation of the multi-sensor mapping system 100 and may provide a storage environment for the mapping system component. In at least one embodiment, the system management unit 125 includes a power unit 205, a communication unit 210, a system processing unit 215, an optional display 220, storage media including a memory unit 225 and an optional motor 320.

The system processing unit 215 may include any suitable processor, controller or digital signal processor that can provide sufficient processing power depending on the configuration, purposes and requirements of the multi-sensor mapping system 100, as is known by those skilled in the art. For example, the system processing unit 215 may include a lower power (i.e. simpler) processor compared to the data processing unit 130.

The system management unit 125 includes power unit 205. The power unit 205 can be any suitable power source that provides power to the various components of the multi-sensor mapping system 100 such as a power adaptor that is connected to the mains power line through an electrical outlet. Alternatively, the power unit 205 may receive power from a rechargeable battery pack or disposable batteries depending on how multi-sensor mapping system 100 is implemented as is known by those skilled in the art.

The display 220 can be used to receive user inputs and display various outputs to a user. For example, the display 220 can be a touchscreen that can output a Graphical User Interface (GUI) that the user can interact with. The display 220 can be any suitable display that provides visual data depending on the configuration of the multi-sensor mapping system 100. For instance, the display 220 can be a display suitable for a laptop, a computer, a tablet such as an iPad, a smart phone, or a handheld device such as a Liquid Crystal Display (LCD) display and the like. In alternative embodiments, if another device (e.g. cellphone, laptop, etc.) with a display is used to control the system management unit 125 then the display 220 may be optional.

The memory unit 225 can include RAM, ROM, one or more hard drives, one or more flash drives, magnetic storage media, volatile storage, cloud storage, a server or some other suitable data storage elements such as disk drives, optical storage media, etc. The memory unit 225 may be used to store data and/or software instructions (i.e. program code) for implementing an operating system and programs as is commonly known by those skilled in the art. For instance, the operating system provides various basic operational processes for the multi-sensor mapping system 100. The programs can include various user programs so that a user can interact with the multi-sensor mapping system 100 to perform various functions such as, but not limited to, at least one of calibration, controlling orientation of the range sensor, performing mapping scans using the range sensor, performing trajectory and orientation recordings through the position and orientation of the device 102, monitoring real time range data and/or the POS data from the POS 110 and the real time monitoring of the data synchronization status.

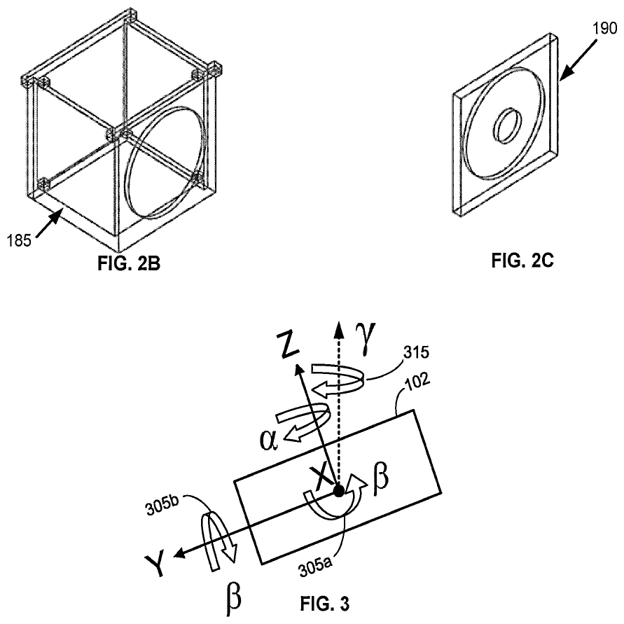

The motor 320 may be optional in certain cases where the orientation of the device 102 is manually adjusted by the operator. However, the motor 320 may be used in embodiments where the orientation of the device 102 is desired to be controlled in a remote and/or automated fashion. For example, the motor 320 may include a miniaturized pan and tilt head (e.g. 2 motors are combined into one unit) so that it can provide for rotation along two axes (e.g. Gamma and/or Beta as described in FIG. 3). In some embodiments, the rotation provided by the motor 320 can be controlled wirelessly.

The system processing unit 215 may access the memory unit 225 to load the software instructions from any of the programs for executing the software instructions in order to control the multi-sensor mapping system 100 to operate in a desired fashion. For example, the system processing unit 215 may be configured to generate and/or receive communication and control signals 155, 160, 165 corresponding to range sensor 105, the POS 110 and the data processing unit 130 respectively.

In at least one embodiment, the communication unit 210 may be used for communication between the system management unit 125 and the multiple sensors of the multi-sensor mapping system 100. For example, the communication unit 210 can be used to send and receive communication and control signals 155 between the system management unit 125 and the range sensor 105, the communication and control signals 160 between the system management unit 125 and the POS 110, and the communication and control signals 165 between the system management unit 125 and the data processing unit 130. The various communication and control signals 155, 160 and 165 can include setup parameters, instructions and/or operational parameters. Accordingly, the communication unit 210 may include various interfaces such as at least one of a serial port, a parallel port, a Firewire port or a USB port, as well as communication hardware such as a Local Area Network (LAN) or Ethernet controller, or a modem, a digital subscriber line connection or a wireless radio, as described below, for communicating remotely with other devices.

For example, the POS 110 generates the sequential synchronization Pulse Per Second PPS signal 145 and a NMEA $GPRMC message 150, the range sensor 105 receives the PPS signal 145 through a dedicated wire and the $GPRMC message 150 through a serial RS-232 interface at a baud rate of 9600 through the communication unit 210. Upon signal reception and synchronization of the PPS signal 145 and the $GPRMC message 150, the range data from the range sensor 105 is timestamped according to the embedded Coordinated Universal Time UTC time standard. In order to ensure precise synchronization, the $GPRMC message reception occurs within a time tolerance after the rising edge of the PPS signal 145 as indicated by the range sensor characteristics. Subsequently, the time stamped range data from the range sensor 105 is stored in the memory unit 225 through an interface at the communication unit 210 such as an Ethernet interface. The communication connection between the range sensor 105 and the memory unit 225 may be implemented by adjusting the corresponding network IP addresses of both the range sensor 105 and the system processing unit 215. For example, in some embodiments, an external mini Ethernet interface may be utilized to simultaneously allow for the monitoring of the data from the POS 110 over a different IP address which links the POS 110 to the system processing unit 215 as well. However, other communication connections can be used in other embodiments.

Alternatively, or in addition thereto, in at least one embodiment, the communication unit 210 can include a radio that communicates utilizing CDMA, GSM, GPRS or Bluetooth protocol according to standards such as IEEE 802.11a, 802.11b, 802.11g, or 802.11n. This allows the communication unit 210 to be used for wireless communication between the multi-sensor mapping system 100 and another electronic device that is remote from multi-sensor mapping system 100. In such cases, the user (i.e. the operator) can remotely control, send input data to and/or receive measured data or other types of data from the multi-sensor mapping system 100.

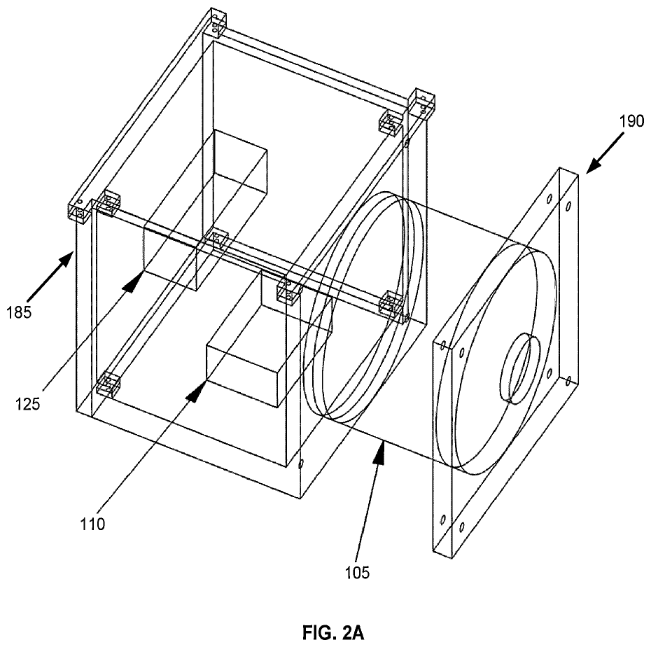

Reference is next made to FIGS. 2A to 2C showing isometric views of at least some of the physical components of the multi-sensor mapping system 100 according to an example embodiment of the present disclosure. FIG. 2A shows the relative placement of the range sensor 105, the POS 110 and the system management unit 125 inside a device housing 185 which includes a plate 190. In at least one embodiment, a three-axis gimbal system (not shown in FIG. 2A) can be used for coupling the housing 185 of the mapping system 100 to a mounting platform. The internal spinning axis of the range sensor 105 is platform-independent; i.e. the internal spinning axis of the range sensor 105 is fixed relative to the range sensor 105 itself regardless of the mounting configuration. One end of the range sensor 105 is coupled to a wall of the housing 185 while an opposite end of the range sensor 105 maybe coupled to a plate 190.

In at least one embodiment, additional sensors may be mounted on one or more free surfaces of the housing 185. This feature allows for flexible and modular operation of the multi-sensor mapping system 100. For example, the housing 185 may be pre-marked (e.g. labelled during manufacturing) showing available locations for the placement of additional sensors. The pre-marked locations can be provided to system management unit 125 so the relative locations of the different sensors is known and these locations can be used to generate the mapping data. In some cases, the placement of additional sensors may also be selected to increase the robustness of the multi-sensor mapping system 100 by controlling the center of gravity of the multi-sensor mapping system 100 to be near its' coupling point to the platform (for example, and without limitation, a tripod, car or a drone). In some cases, the placement of additional sensors may also be chosen based on the platform being used and the required field-of-view.

It should be understood that the embodiment shown in FIGS. 2A to 2C for the device housing 185 and sensor arrangement is just one example. Accordingly, there may be other arrangements for the housing 185, as well as positions the range sensor 105, the POS 110 and the system management unit 125 in other embodiments and the example of FIGS. 2A-2C should not be limiting.

Reference is now made to FIG. 3 showing a visual representation of the three degrees of freedom of rotation of the multi-mapping system 100, according to an example embodiment of the present disclosure. The range sensor 105 is configured for rotation with three degrees of freedom comprising an internal rotation angle around its spinning axis represented by α (“alpha”) in the figures, a vertical rotation angle 305 around one of two mutually orthogonal horizontal axes (e.g. vertical rotation angle 305a around a horizontal X axis and a vertical rotation angle 305b around a horizontal Y axis shown in FIG. 3 which are both represented by β “Beta” in the figures) and a horizontal rotation angle 315 around an absolute vertical Z axis relative to a ground plane represented by γ (“gamma”) in the figures.

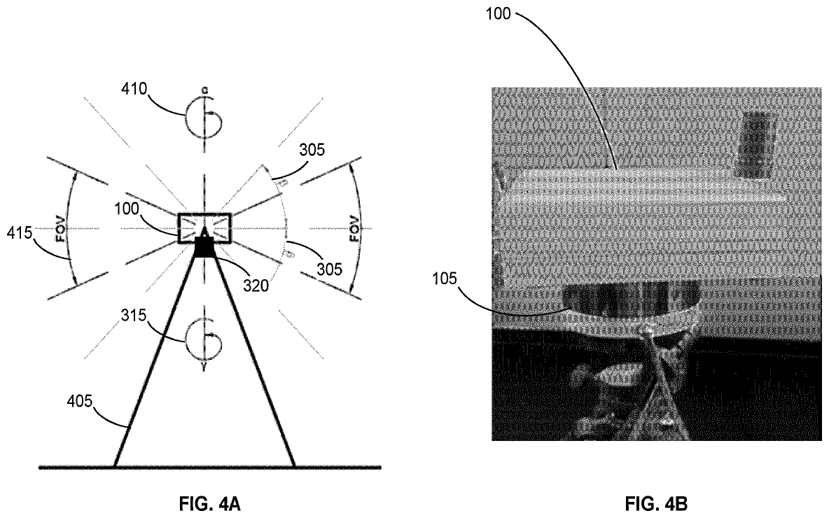

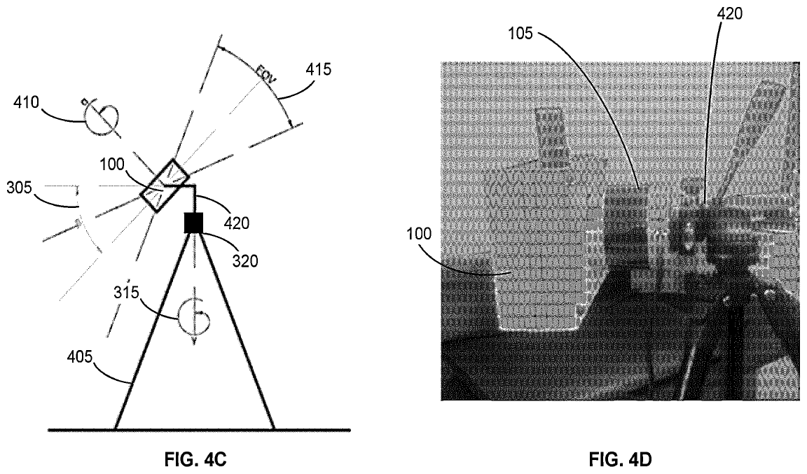

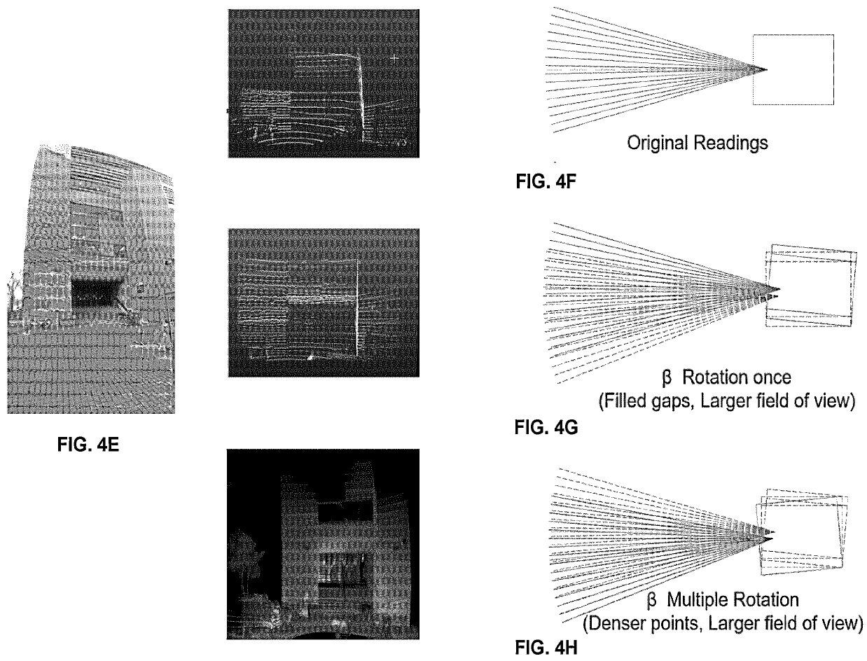

In at least one embodiment, the system management unit 125 can control the vertical rotation angle 305a to expand a field-of-view of the range sensor 105 and to increase a density of target points mapped by the range sensor 105. Further, the system management unit 125 may control the horizontal rotation angle 315 to increase a density of target points mapped by the range sensor 105. The expanded field-of-view and increased density of mapped target points may provide the advantage of increased sampling efficiency during mapping, as described further below with reference to FIGS. 4A-6. For example, and without limitation, in a drone-based airborne mapping application, the expanded field-of-view and increased density of mapped target points improves efficiency by allowing a larger amount of range data to be collected while the drone is stationary.

The disclosed embodiments of the multi-sensor mapping system 100 use a small form-factor and low-weight components that enable operation in any of a stationary, ground mobile or airborne mode of operation. Reference is next made to FIGS. 4A and 4B, which show the multi-sensor mapping system 100 operated in a first configuration in stationary mode, according to an example embodiment of the present disclosure. The multi-sensor mapping system 100 is initially mounted on a stationary platform with the internal spinning axis 410 being at or around the absolute vertical. For example, and without limitation, the multi-sensor mapping system 100 is mounted on a tripod 405 shown in FIG. 4A. The internal rotation angle 410 corresponds to the internal rotation angle of the range sensor 105 (shown in FIG. 4B) of the multi-sensor mapping system 100 about its internal spinning axis. For the example embodiment of FIGS. 4A and 4B, the range of the internal rotation angle 410 is 0 to 360° and allows for a field-of-view 415 for the range sensor 105. The multi-sensor mapping system 100 can be rotated around a horizontal axis to provide a vertical rotation angle 305. As shown in FIG. 4A, the vertical rotation angle 305 can be practically controlled between 0° and 90° and enables the range sensor 105 to have an expanded field-of-view, which allows for a greater density of scan points in the vertical direction. An example of this is shown in FIGS. 4E-4H which is described in further detail below. The vertical rotation angle 305 can be manually controlled by a user or automatically controlled by a controller such as, for example, by the system processing unit 215 of the system management unit 125 that controls a motor 320 which rotatably couples the housing 185 of the device 102 to the tripod 405. For the example embodiment of FIGS. 4A and 4B, the multi-sensor mapping system 100 is rigidly attached to the tripod 405, and the horizontal rotation angle 315 about the absolute vertical axis (γ) is zero.

Reference is next made to FIGS. 4C and 4D showing the multi-sensor mapping system 100 operated in a second configuration in stationary mode, according to an example embodiment of the present disclosure. The multi-sensor mapping system 100 is mounted on a stationary platform with its internal spinning axis almost horizontal. For example, and without limitation, multi-sensor mapping system 100 is mounted on a tripod 405 using an arm extension 420 as shown in FIGS. 4C and 4D. The internal rotation angle 410 corresponds to the rotation of the range sensor 105 (shown in FIG. 4D) of the multi-sensor mapping system 100 about its internal spinning axis. For the example embodiment of FIGS. 4C and 4D, the internal rotation angle 410 ranges from 0 to 360° and allows for a field-of-view 415 for range sensor 105. The device 102 of the multi-sensor mapping system 100 can be rotated around a horizontal axis to provide a vertical rotation angle 305 (e.g. β). As shown in FIG. 4C, the vertical rotation angle 305 can be controlled between 0° and 90° and enables range sensor 105 to have an expanded field-of-view. The vertical rotation angle 305 can be manually controlled by a user or automatically controlled by a controller such as, for example, by system management unit 125. For the example embodiment of FIGS. 4C and 4D, the arm extension 420 enables a 360° horizontal rotation angle 315 around a vertical axis. The horizontal rotation angle 315 can be manually controlled by a user or automatically controlled by a controller such as, for example, by the system processing unit 215 of the system management unit 125 that controls the motor 320 which rotatably couples the housing 185 of the device 102 to the tripod 405.

The three degrees of freedom of rotation (e.g. internal rotation angle 410, vertical rotation angle 305 and horizontal rotation angle 315) enable the multi-sensor mapping system 100 to have the widest-possible coverage area with a 360° horizontal and a vertical field-of-view. Further, the three degrees of rotation enable the multi-sensor mapping system 100 to map additional target points between the scan lines corresponding to the internal rotation of the laser source of the range sensor 105. This may provide the advantage of generating denser 3D geo-referenced point cloud data. An example of this is shown in FIGS. 4F-4H, where an example of an area that is to be mapped is shown in FIG. 4E, a point cloud of the mapped area that is obtained using a conventional mapping device is shown in FIG. 4F, and point clouds of the mapped data that are obtained using a multi-sensor mapping system with increased scan coverage in accordance with the teachings herein is shown in FIGS. 4G-4H. The point cloud data of FIGS. 4G-4H are much more representative of the mapped area that the conventionally obtained point cloud data shown in FIG. 4F, where FIG. 4H includes a great variation of the angle β to obtain even more dense sampling of the structure of FIG. 4E.

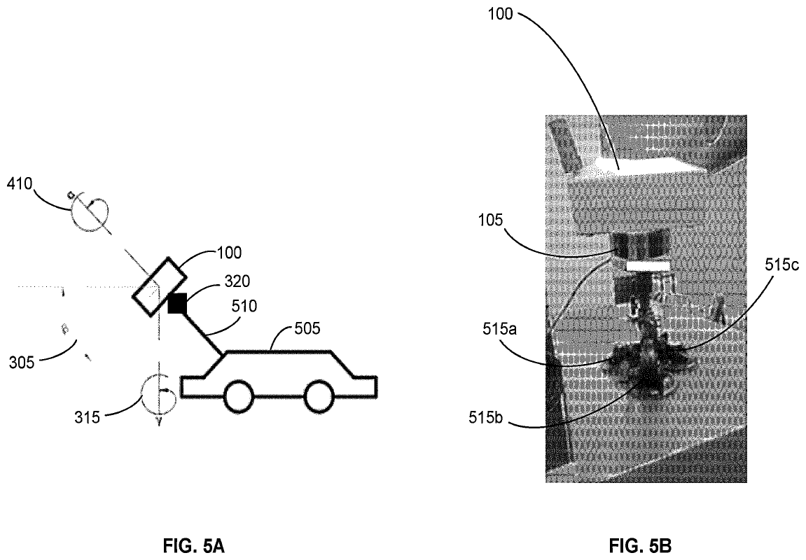

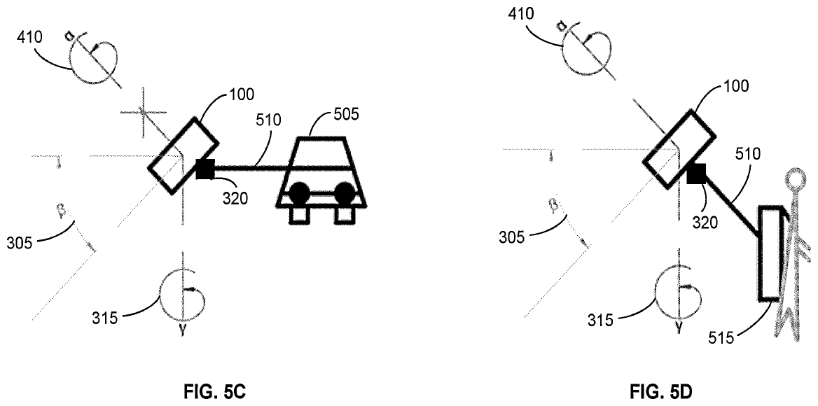

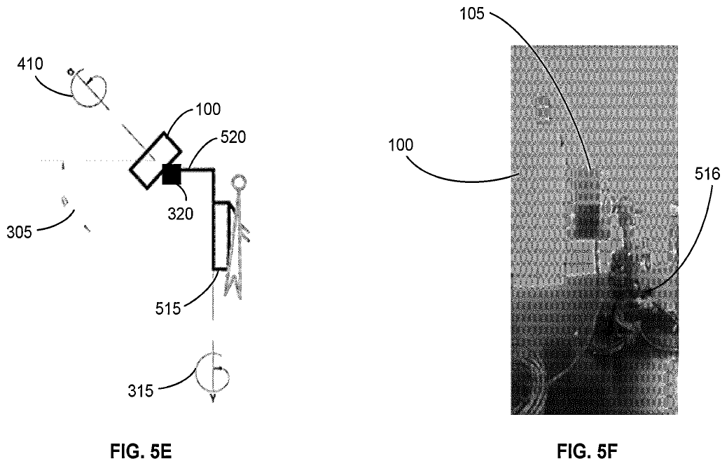

Reference is next made to FIGS. 5A-5F showing the multi-sensor mapping system 100 operated in a ground mobile mode, according to an example embodiment of the present disclosure. For example, and without limitation, the multi-sensor mapping system 100 is mounted on the roof of a vehicle 505 using a coupler (i.e. mount) 510, as shown in FIG. 5A. As shown by the prototype in FIG. 5B, the coupler 510 can be attached to a platform using suction cups 515a, 515b, and 515c or some other suitable attachment means. The light-weight and small form-factor of the multi-sensor mapping system 100 can provide flexibility in choosing the mounting location on the ground mobile platform. For example, unlike conventional systems, the multi-sensor mapping system 100 is not limited to being mounted on the roof of the vehicle 505. Instead, the multi-sensor mapping system 100 may be mounted at many different locations including the left or right side walls, or the front or the back of vehicle 505. For example, in at least one embodiment, the multi-sensor mapping system 100 is mounted on the side of vehicle 505 using coupler 510, as shown in FIG. 5C.

The internal spinning axis of the range sensor 105 (shown in FIG. 5B) is almost vertical. The internal rotation angle 410 corresponds to the rotation of the range sensor 105 of the multi-sensor mapping system 100 about its internal spinning axis. For the example embodiments of FIGS. 5A and 5C, the range of the internal rotation angle 410 is 360°. The device 102 of the multi-sensor mapping system 100 can be rotated around a horizontal axis to provide a vertical rotation angle 305. The vertical rotation angle 305 can be controlled between 0° and 90° and enables the range sensor 105 to have an expanded field-of-view. The vertical rotation angle 305 can be manually controlled by a user or automatically controlled by a controller such as, for example, by the system processing unit 215 of the system management unit 125 that controls the motor 320 which rotatably couples the housing 185 of the device 102 to the vehicle 505. Any initial orientation alignment of the multi-sensor mapping system 100 can be used for the vertical rotation angle 305. For the example embodiments of FIGS. 5A and 5C, while the coupler 510 is rigidly attached to the vehicle 505, and the horizontal rotation angle 315 around the absolute vertical axis ranges from 0 to 360°.

In at least one embodiment, the multi-sensor mapping system 100 is mounted on a backpack 515 of a user using a coupler 510 in a first configuration, as shown in FIG. 5D. The light-weight and small form-factor of the multi-sensor mapping system 100 enables mounting the system 100 on multiple platforms such as, for example, and without limitation, a user's backpack or a user's waist-belt, or it may be hand-held by a user. The internal rotation angle 410 corresponds to the rotation of the range sensor 105 of the multi-sensor mapping system 100 about its internal spinning axis. For the example embodiment of FIG. 5D, the range of the internal rotation angle 410 is 360°. The device 102 of the multi-sensor mapping system 100 can be rotated around a horizontal axis to provide a vertical rotation angle 305. The vertical rotation angle 305 can be controlled between 0° and 90° and enables the range sensor 105 to have an expanded field-of-view. The vertical rotation angle 305 can be manually controlled by a user or automatically controlled by a controller such as, for example, by the system processing unit 215 of the system management unit 125 that controls the motor 320 which rotatably couples the housing 185 of the device 102 to the coupler 510. Any initial orientation alignment of the multi-sensor mapping system 100 can be used for vertical rotation angle 305. For the example embodiment of FIG. 5D, the coupler 510 is rigidly attached to backpack 515, and the horizontal rotation angle 315 around the absolute vertical axis can range from 0 to 360°.

In at least one embodiment, the multi-sensor mapping system 100 is mounted on the backpack 515 of a user using an arm extension 520 in a second configuration, as shown in FIG. 5E. The arm extension 520 can be attached to the backpack 515 using a suitable mechanical attachment 516 such as, for example, a bracket with bolts, as shown in FIG. 5F. The internal rotation angle 410 corresponds to the rotation of the range sensor 105 of the multi-sensor mapping system 100 about its internal spinning axis. For the example embodiment of FIG. 5E, the range of the internal rotation angle 410 is 360°. The multi-sensor mapping system 100 can be rotated around a horizontal axis to provide a vertical rotation angle 305. The vertical rotation angle 305 can be controlled between 0° and 90° and enables range sensor 105 (shown in FIG. 5F) to have an expanded field-of-view whereas in conventional mapping systems this angle β is constant. The vertical rotation angle 305 can be manually controlled by a user or automatically controlled by a controller such as, for example, by the system processing unit 215 of the system management unit 125 that controls the motor 320 which rotatably couples the housing 185 of the device 102 relative to the arm extension 520. Any initial orientation alignment of the multi-sensor mapping system 100 can be used for vertical rotation angle 305. For the example embodiment of FIG. 5E, the arm extension 520 enables the range of the horizontal rotation angle 315 to be 360° around the absolute vertical axis.

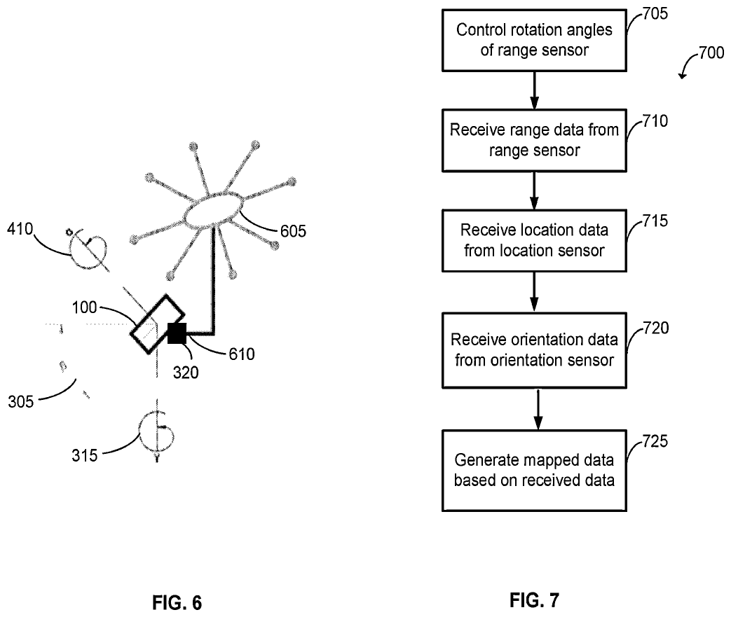

Reference is next made to FIG. 6 which shows a schematic of the multi-sensor mapping system 100 operated in an airborne mode, according to an example embodiment of the present disclosure. The multi-sensor mapping system 100 is mounted on a flying vehicle, such as a drone 605, using an arm extension 610, as shown in FIG. 6. The internal rotation angle 410 corresponds to the rotation of the range sensor 105 of the multi-sensor mapping system 100 about its internal spinning axis. For the example embodiment of FIG. 6, the range of the internal rotation angle 410 is 360°. The multi-sensor mapping system 100 can be rotated around a horizontal axis to provide a vertical rotation angle 305. The vertical rotation angle 305 can be controlled between 0° and 180° and enables the range sensor of multi-sensor mapping system 100 to have an expanded field-of-view. The vertical rotation angle 305 can be manually controlled by a user or automatically controlled by a controller such as, for example, by the system processing unit 215 of the system management unit 125 that controls the motor 320 which rotatably couples the housing 185 of the device 102 to the arm extension 610. Any initial orientation alignment of the multi-sensor mapping system 100 can be used for vertical rotation angle 305. For the example embodiment of FIG. 6, the horizontal rotation angle 315 around the absolute vertical axis can be flexibly controlled, either to be fixed or can be rotated from 0-360° depending on the mode of operation and the application at hand. For example, it may be fixed if the drone flies around while obtaining data, or can be rotated from 0-360° if the drone is in the air but is stationary when obtaining data.

Reference is next made to FIG. 7, which shows a flowchart of an example embodiment of a method 700 for generating mapping data using a multi-sensor mapping system in accordance with the teachings herein. In at least one embodiment, method 700 can be performed by the multi-sensor mapping system 100 described herein. The multi-sensor mapping system 100 comprises a range sensor configured to sense a distance between the range sensor and a target point and generate range data; a location sensor configured to sense a location of the range sensor and generate location data; and an orientation sensor configured to sense an orientation of the range sensor in relation to a gravitational frame of reference and generate orientation data. For example, where there are separate data and system processing units 130 and 215, then the system processing unit 215 may perform acts 705 to 720 and the data processing unit 130 can perform act 725. In embodiments where only a single processing unit is used for the multi-sensor mapping system, then all of the acts of method 700 may be performed by the single processing unit.

The method 700 begins at act 705, with controlling the rotation angles corresponding to the three degrees of freedom of the range sensor during its operation. For example, the system management unit 125 of the multi-sensor mapping system 100 can control the rotation angles used by the multi-sensor mapping system 100 for recording data (more specifically the range sensor 105 operatively coupled to the POS 110), depending on the mode of operation, as described hereinbefore with reference to FIGS. 4A-6. In at least one embodiment, the vertical rotation angle and/or the horizontal rotation angle of the range sensor can be controlled to expand the sensor field-of-view and the range sensor point density by varying the angle β and/or by varying the angle γ and mapping the data obtained by the range sensor over ranges of at least one of these angles. The range sensor 105 can operate at different rotation angles to measure distance to target points scanned by the range sensor and generate corresponding range data. The internal spinning frequency of the range sensor 105 can also be controlled by the operator to obtain the range data with a desired sampling rate. A location sensor and an orientation sensor (e.g. of the POS 110) can operate at the same time as the operation of the range sensor to generate corresponding location and orientation data of the range sensor during its operation, as explained previously for the multi-sensor mapping system 100.

At act 710, the range data generated by the range sensor at act 705 is recorded. For example, the system processing unit 215 of the multi-sensor mapping system 100 can receive the range data generated by the range sensor 105 and store the generated range data at the memory unit 225.

At act 715, the location data generated by the location sensor at act 705 is recorded. For example, the system processing unit 215 of the multi-sensor mapping system 100 can receive the location data, generated by the location sensor 115, from the POS 110, and store the generated location data at the memory unit 225.

At act 720, the orientation data generated by the orientation sensor at act 705 is recorded. For example, the system processing unit 215 of the multi-sensor mapping system 100 can receive the orientation data, generated by the orientation sensor 120, from the POS 110, and store the generated location data at the memory unit 225.

It should be noted that in alternative embodiments, the order of acts 710 to 720 may be different or they may be performed in parallel for each of the sensors obtaining their respective data. The different types of data are then saved to the memory unit 225 sequentially.

At act 725, the method 700 moves to generate the mapping data based on the recorded range data, location data and orientation data. For example, the data processing unit 130 of the multi-sensor mapping system 100 can process the received data to generate 3D geo-referenced point cloud data. The processing of the received data, performed by the data processing unit 130, may be performed according to a processing method that is described in FIG. 8.

Referring now to FIG. 8, shown therein is a flowchart of an example embodiment of a processing method 800 that can be used with the method 700 of FIG. 7 for processing raw mapping data to generate mapping data for data obtained by a multi-sensor mapping system in accordance with the teachings herein. In at least one embodiment, the method 800 can be performed at act 725 of the method 700 by the data processing unit 130 of the multi-sensor mapping system 100 or by a single processing unit in embodiments where the functionality of the data processing unit 130 and the system processing unit 215 are provided by the single processing unit. Alternatively in some embodiments at least some acts of method 800 may be performed by the system processing unit 215.

As described hereinbefore with reference to FIG. 1A, the multi-sensor mapping system 100 can be implemented to enable accurate signal communication and synchronization between the different sensor components. For example, the pulse-per-second signal 145 can be used to synchronize the operation of the POS 110 with the range sensor 105. The POS 110 also transmits, to the range sensor 105, a GPRMC message 150 or the like that includes time-stamp and GNSS-based location data.

The method 800 begins at act 805, with importing, from the memory unit 225, range data that is generated by a range sensor. For the example embodiment of FIG. 1A, the data processing unit 130 receives the 3D time-stamped point-cloud data 170 that is generated by the range sensor 105.

At act 810, the location and orientation data that is generated by the location and orientation sensors respectively is imported from the memory unit 225. For the example embodiment of FIG. 1A, the data processing unit 130 receives the location and orientation data 175 from the POS 110.

At act 815, the method 800 involves pre-processing the range data by parsing the raw range data and performing frame discretization. In at least one embodiment, the method 800 enables complete user control for processing the imported range data by allowing the user to select each individual frame (or each individual scan) or group of frames (or a group of scans) of the range data for processing. This may provide the advantages of: (a) increased user control in choosing key frames, a desired frame-rate, or frames for later analysis (which can speed up the processing time of key frames); (b) faster analysis by allowing parallel computation or cloud-based computation of the imported data and (c) increased efficiency by allowing targeted analysis.

At act 820, the method 800 involves pre-processing the location and orientation data. In general, the location data can be characterized as having a low update rate but does not suffer from data drift while the orientation data can be characterized as having a high update rate and a high accuracy but suffers from data drift over time. For example, the data processing unit 130 may receive: (1) GNSS location data that has a low update rate but does not suffer data drift; and (2) inertial measurement unit (IMU) data with a high update rate but suffers from data drift with time. In at least one embodiment, the data processing unit 130 may use the received GNSS location data to constrain the drift in the received IMU data. This may be done, for example, and without limitation, by the data processing unit 130 integrating the GNSS data and the IMU data by applying a Kalman filtering algorithm or any similar algorithm such as a particle filter, for example. The Kalman filter is a recursive least-squares estimation algorithm in which the estimated state from the previous time step is combined with the current measurement to compute the current state. Thus, the Kalman filter utilizes the measurements from the GNSS receiver (i.e. position sensor) to estimate the errors in the orientation measurements of the IMU sensor thereby enhancing the accuracy accordingly. The data processing unit 130 may also enhance the accuracy of the integration process by applying forward and backward data smoothing along with zero velocity updates (ZUPT), which may involve using mapped points where the multi-sensor mapping system 100 is not moving and these mapped points can be used to enhance the accuracy of the calculated location. The ZUPT allows the errors in the IMU measurements to be bounded in-between stop conditions as the velocity at these points is about zero m/s thus enhancing the IMU measurements accordingly.

Further, in at least one embodiment, the multi-sensor mapping system 100 may be equipped with sensors that can receive real-time GNSS corrections that can be included in the real-time processing of method 800 or in post-processing. For example, in the real time kinematics corrections case, the multi-sensor mapping system 100 may be equipped with a radio modem that can receive the corrections sent from a base station as radio waves. Alternatively, the corrections may be sent over cellular networks and in this case a cellular modem is used. In another alternative, some GNSS receivers may allow the reception of satellite-based corrections directly by the receiver.

At act 825, the method 800 moves to interpolate the preprocessed received range data with the preprocessed location and orientation data by synchronizing the timestamps of these data series. The pre-processed range data and the pre-processed location and orientation data typically have different sampling rates. A common time-frame reference can be used to link the range data with location and orientation data. Vectorization can then be used on the synchronized range, orientation and position data sets to integrate these data sets into point cloud data.

In at least one embodiment, an application-dependent time-step interval may be chosen to interpolate the lower frequency location and orientation data (i.e. obtained at a low sampling rate), which are matched and then joined with the higher frequency range data (i.e. obtained at a higher sampling rate). For example, the time-step interval can change based on the rate of change of the position data or the orientation data. For example, a smaller time-step interval can be chosen for interpolation when the rate of change of the position data or the orientation data is high. This may depend on the mode of operation of the multi-sensor mapping system. For example, the rate of change of the position data can be higher in a mobile ground mode depending if a vehicle is being used and the speed of the vehicle is increased compared to another mobile ground mode where the system is being carried in a backpack. As another example, the rate of change of the orientation data can be higher in the aerial mode compared to the other modes of operation.

Accordingly, in at least one embodiment, different ranges for the time-step interval may be defined for the stationary, ground mobile and aerial mobile modes of operation. During interpolation one of these ranges is selected depending on the mode of operation for the multi-sensor mapping system 100. Then the time step for interpolation can be selected within the selected range depending on the rate of change of the data that is being interpolated.

In at least one embodiment, the data processing unit 130 can use vectorization operations to improve the processing time for integrating (i.e. combining together) the preprocessed range, preprocessed orientation and preprocessed location data after interpolation to generate matched data. Instead of using conventional loops to combine these data sets, each column of the data sets can be treated as a vector and the processing can be performed on the complete vector, thereby speeding up the processing. Here, vectorization refers to the process of operating on a single value at a time to operating on a set of values (i.e. a vector) at one time. Modern CPUs provide direct support for vector operations where a single instruction is applied to multiple data (SIMD). For example, a CPU with a 512 bit register can hold sixteen 32-bit single precision doubles and can do a single calculation sixteen times faster than executing a single instruction at a time. The vectorized operations can be combined with threading and multi-core CPUs to obtain orders of magnitude of performance gains (i.e. order of magnitude in reduction in execution time) over systems that do not use vectorization.

At act 835, the method 800 involves transforming the different sensor data sets from different coordinate system (CS) frames to a common mapping coordinate system that uses real world geographic coordinates. The interpolated and matched data from act 830 typically have different coordinate system frames based on the orientation of the sensors from which the data was obtained. For example, the multi-sensor mapping system 100 includes an IMU body CS frame, a GNSS CS frame, a local-level or navigational CS frame, a vehicle CS frame and a (range) sensor CS frame. The IMU body CS frame can be used as a reference CS frame that the other CS frames are transformed to. For example, each point of the range data can be transformed to have the corresponding position and orientation of the orientation sensor.

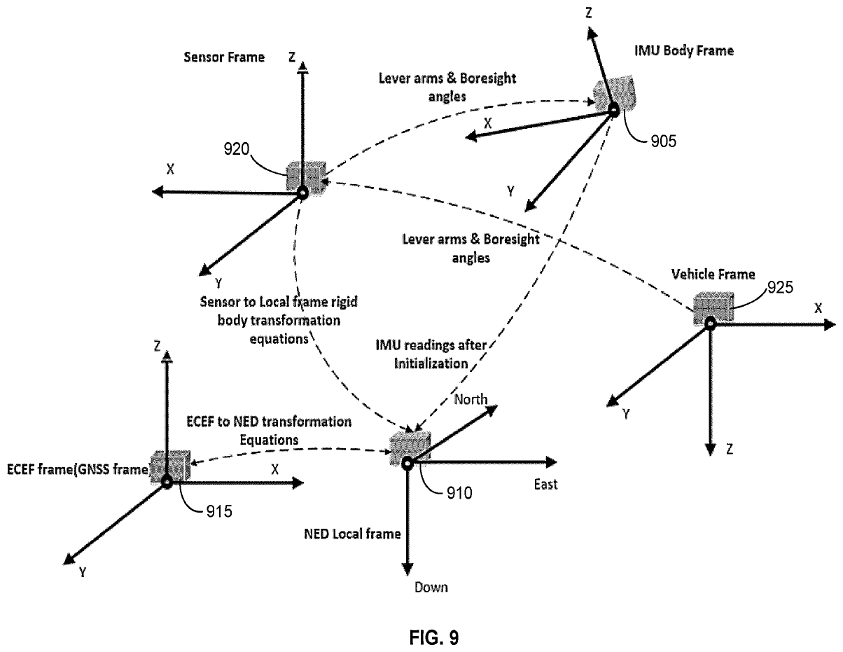

Reference is now made to FIG. 9, which is a visual representation of the boresight angles (e.g. relative orientation) and the lever arms (e.g. distances) between the different coordinate system frames used in a multi-sensor mapping system in accordance with the teachings herein. The transformation may begin by detecting the relation between the IMU body frame 905 and the north-east down directions of a local frame 910. For example, one axis of the local frame 910 can be along the north direction, one axis of the local frame 910 can be along the local eastern direction, and one axis can of the local frame 910 can represent the vertical direction. Alternatively, two right handed variants may be used in alternative implementations: east, north, up (ENU) coordinates or north, east, down (NED) coordinates.

The boresight angles and lever arms between the IMU body frame 905 and the sensor frame 920 (based on pre-marked mounting locations on the system housing described hereinbefore with reference to FIGS. 2A-2C) and the boresight angles and lever arms between the sensor frame 920 and the vehicle frame 925 (based on the operation mode as described hereinbefore with reference to FIGS. 4-6) can be used to relate the sensor frame 920 and the vehicle frame 925 with the local frame 910. The GNSS frame 915 can be transformed to the local frame 910 and used to aid in the pre-processing of the orientation data (described hereinbefore with reference to act 820 of method 800). In at least one embodiment, the data processing unit 130 can continuously map the relation between the different CS frames and combine the location and orientation data to map the trajectory and orientation of the range sensor with reference to the local frame.

Referring back to FIG. 8, at act 840, the method 800 involves combining the transformed trajectory and orientation data obtained during act 835 with the time-stamped range data to generate a 3D geo-referenced point cloud data. For the three data streams, i.e. the IMU (orientation) data, the GNSS (position/location) data, and the range data, act 840 may start by performing signal synchronization between the POS 110 and the range sensor 105 through the PPS 145 and the GPRMC 150 or similar messages to obtain time-stamped range data that is on the same time reference of the POS data. The GNSS and the IMU data may then be combined to obtain enhanced trajectory (i.e. positions) and orientation data that is more accurate than using either position or orientation sensors alone. The enhanced trajectory and orientation data is then interpolated, as described previously, and then matched to the range data based on finding the same time stamps in the enhanced trajectory and orientation data and the range data. At this point, the range data can be geo-referenced using real world mapping coordinates.

At act 845, the method 800 moves to perform post-processing on the 3D geo-referenced point cloud data generated at act 845. For example, and without limitation, the post-processing may include noise filtering since there may be erroneous points measured by the range sensor. Thus, a neighborhood filter may be used to check the relation between each range point and its surrounding range points within a specified area. For example, if a given range point's distance to its neighboring range points is greater than a threshold distance from the standard deviation of the neighboring range points then the given range point may be considered as an outlier and removed from the point cloud data. After noise filtering, the filtered 3D geo-referenced point cloud data may be exported into standard data formats. The generated 3D geo referenced point cloud data can then be used in many different Geographic Information Systems (GIS) applications such as, but not limited to, one or more of surveying, remote sensing, volume calculations, virtual reality and 3D modelling. The generated 3D geo referenced point cloud data can also be used to generate other geospatial products like digital surface models, or digital elevation models which are crucial in many hydrological applications.

In another aspect, in at least one alternative embodiment, the range sensor may be configured to obtain the range data when the system 100 is incrementally moved in a given direction resulting in the obtained range data covering an extended field of view. In such cases, the data processing unit 130 may be configured to use the range data that is obtained over the larger field of view to increase density for the generated three-dimensional geo-referenced point cloud data. The movement in the given direction may be along an up or down direction. The movement may be done manually, by using an actuator that is automatically controlled to move the system 100 along the given direction under the control of a controller such as, for example, the system management unit. Alternatively, the device of the system may be placed on a spring or other similar physical mechanism that can move the system 100.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A multi-sensor mapping system for generating mapping data, the multi-sensor mapping system comprising:
a device having:
a housing that is platform independent and adapted for coupling to different platforms for different modes of operation;
a range sensor that is mounted to the housing and configured to sense a distance between the range sensor and a target point and generate range data;
a location sensor that is mounted to the housing and configured to sense a location of the range sensor and generate location data;
an orientation sensor that is mounted to the housing and configured to sense an orientation of the range sensor in relation to a gravitational frame of reference and generate orientation data; and
a system management unit that is operatively coupled to the sensors and configured to control the operation of the sensors in a stationary mode, a ground mobile mode or an airborne mode.

2. The system of claim 1, wherein the system further comprises a data processing unit that is communicatively coupled to the device for receiving the range data, location data and orientation data and generating the mapping data by combining the received range data, location data and orientation data into three-dimensional geo-referenced point cloud data.

3. The system of claim 1 or claim 2, wherein the range sensor is rotatably mounted to the housing for rotation with three degrees of freedom comprising:
an internal rotation angle around a spinning axis of the range sensor;
a vertical rotation angle around one of two mutually orthogonal horizontal axes; and
a horizontal rotation angle around an absolute vertical axis that is orthogonal to the two mutually orthogonal horizontal axes.

4. The system of claim 3, wherein the system management unit is configured to:
control at least one of the vertical rotation angle and the horizontal rotation angle of the range sensor to perform at least one of expanding a field-of-view of the range sensor and increasing a density of target data points that is sensed by the range sensor.

5. The system of any one of claims 2 to 4, wherein the data processing unit is configured to generate the mapping data by:
pre-processing the received range data through frame data discretization;
pre-processing the received location and orientation data;
interpolating the pre-processed location and orientation data using synchronized timestamps and an application-dependent step interval;
combining the interpolated data by using vectorization;
transforming coordinate system frames for the combined data to a common coordinate system frame to generate transformed data;
generating a three-dimensional geo-referenced point cloud data from the transformed data; and
post-processing the three-dimensional geo-referenced point cloud data.

6. The system of claim 5, wherein the data processing unit is configured to receive a first control input of selected frames from an operator of the system and use the first control input for analysis and processing the range data.

7. The system of claim 5 or claim 6, wherein the data processing unit is configured to determine the step interval using different interval ranges depending on whether the system is operating in the stationary mode, the ground mobile mode, or the airborne mode.

8. The system of any one of claims 1 to 7, wherein the system management unit and the data processing unit employ at least one common processor.

9. The system of any one of claims 1 to 8, wherein the range sensor is configured to obtain the range data when the system is incrementally moved in a given direction resulting in the obtained range data covering an extended field of view.

10. The system of claim 9, wherein the data processing unit is configured to use the range data obtained over the larger field of view to increase density for the generated three-dimensional geo-referenced point cloud data.

11. A method for generating mapping data using a multi-sensor mapping system, wherein the method comprises:
configuring the multi-sensor system for operating in a stationary mode, a ground mobile mode or an airborne mode, where the multi-sensor mapping system comprises a range sensor configured to sense a distance between the range sensor and a target point and generate range data; a location sensor configured to sense a location of the range sensor and generate location data; and an orientation sensor configured to sense an orientation of the range sensor in relation to a gravitational frame of reference and generate orientation data;
controlling, during operation of the range sensor, an internal rotation angle of the range sensor around a spinning axis, a vertical rotation angle of the range sensor around one of two mutually orthogonal horizontal axes and a horizontal rotation angle of the range sensor around a vertical axis orthogonal to the two mutually orthogonal horizontal axes;
receiving the range data from the range sensor;
receiving the location data from the location sensor;
receiving the orientation data from the orientation sensor; and
generating the mapping data by combining the received range data, location data and orientation data.

12. The method of claim 11, wherein the mapping data is generated by:
pre-processing the received range data through frame data discretization;
pre-processing the received location and orientation data;
interpolating the pre-processed location and orientation data using synchronized timestamps and an application-dependent step interval;
combining the interpolated data by using vectorization;
transforming coordinate system frames for the combined data to a common coordinate system frame to generate transformed data;
generating a three-dimensional geo-referenced point cloud data from the transformed data; and
post-processing the three-dimensional geo-referenced point cloud data.

13. The method of claim 12, wherein the method comprises receiving a first control input of selected frames from an operator of the system for analysis and processing the range data.

14. The method of claim 12 or claim 13, wherein the method comprises determining the step interval using different interval ranges depending on whether the system is operating in the stationary mode, the ground mobile mode, or the airborne mode.

15. The method of any one of claims 11 to 14, wherein the method further comprises obtaining the range data when the system is incrementally moved in a given direction resulting in the obtained range data covering an extended field of view.

16. The method of claim 15, wherein the method comprises using the range data obtained over the larger field of view to increase density for the generated three-dimensional geo-referenced point cloud data.
